(19) United States
(12) Patent Application Publication
(10) Pub. No.: US 2004/0078317 A1
(43) Pub. Date: Apr. 22, 2004

(54) Method and system for generating a dual quote

(76) Inventors: Anne E. Allen, Cranford, NJ (US); William C. Werben, Brooklyn, NY (US)

Correspondence Address: Chris L. Holm, Milbank, Tweed, Hadley & McCloy LLP, 1 Chase Manhattan Plaza, New York, NY, 10005-1413, US

(21) Appl. No.: 10/370,380

(22) Filed: Feb. 19, 2003

Related U.S. Application Data
(60) Provisional application No. 60/419,274, filed on Oct. 17, 2002.

(51) Int. Cl. G06F 17/60

(52) U.S. Cl. 705/37

(57) ABSTRACT

An inside quote and a liquidity quote are generated for a security. The inside quote is a conventional best bid and best offer with associated size or number of shares at each price. The liquidity quote is priced outside the best bid and offer and includes the size or number of limit orders priced between the respective bid and offer prices of the inside quote and the liquidity quote. Firm trader or investor interest that is not reflected in limit orders is also included in the size of the liquidity quote. The firm interest may be anonymous. Updates to the liquidity quote occur on a less frequent basis than the inside quote. A bunching parameter helps to determine the liquidity quote update frequency.

### BACKGROUND

1. Field of the Invention

The invention relates to the field of securities markets and more particularly to the field of price and size quotations in securities markets.

2. Description of the Related Art

Price quotation of the most recent bid and offer prices for securities is known, and systems and methods to display limit order prices are also known. What is needed are systems and methods to show market liquidity in the form of firm quotes at prices other than the best bid and best offer prices, where the liquidity reflects the size of firm interest that is not reflected in published limit orders.

The preceding description is not to be construed as an admission that any of the description is prior art relative to the present invention.

### SUMMARY OF THE INVENTION

In one aspect, the invention provides a method and system to establish a liquidity quote of a security. The method comprising determining an inside quote of the security, the inside quote including a bid and an offer; identifying the size and price of firm orders and firm interest in the security outside the bid and offer of the inside quote; and establishing a liquidity quote of the security by using a predetermined set of criteria and the identified size and price of the firm orders and firm interest outside the bid and offer of the inside quote.

In one aspect, the invention provides a method and system for updating quotes of a particular security. The method comprising determining an inside quote of the security, the inside quote including a bid and an offer; identifying the size and price of orders for the security outside the bid and offer of the inside quote; establishing a liquidity quote of the security by using the identified size and price of the orders outside the bid and offer of the inside quote; updating the inside quote on a regular basis; and updating the liquidity quote on a less frequent basis than the inside quote, wherein the basis for updating the liquidity quote uses a predetermined parameter.

In one aspect, the invention provides a method and system for effecting a transaction for a particular security. The method comprising receiving a liquidity quote of the security, the liquidity quote reflecting a predetermined set of criteria and identified size and price of firm orders and firm interest in the security outside a bid and an offer of an inside quote of the security; and effecting a transaction for the security, the transaction having a transaction price and a transaction size, wherein the transaction price is equal to an offer price of the liquidity quote or equal to a bid price of the liquidity quote, and the transaction size is equal to or less than the respective size of the offer price or bid price of the liquidity quote.

The foregoing specific aspects and advantages of the invention are illustrative of those which can be achieved by the present invention and are not intended to be exhaustive or limiting of the possible advantages that can be realized. Thus, the objects and advantages of this invention will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates an embodiment of a system according to the invention;

FIG. 2 illustrates an embodiment of a screen display according to the invention;

FIG. 3 illustrates an embodiment of a screen display according to the invention;

FIG. 4 illustrates an embodiment of a system according to the invention;

FIG. 5 illustrates an embodiment of a method according to the invention;

FIG. 6 illustrates an embodiment of a method according to the invention;

FIG. 7 illustrates an embodiment of a screen display according to the invention;

FIG. 8 illustrates an embodiment of a screen display according to the invention;

FIG. 9 illustrates an embodiment of a method according to the invention;

FIG. 10 illustrates an embodiment of a method according to the invention;

FIG. 11 illustrates an embodiment of a system according to the invention;

FIG. 12 illustrates an embodiment of a screen display according to the invention;

FIG. 13 illustrates an embodiment of a method according to the invention; and

FIGS. 14-18 illustrate example order execution using embodiments according to the invention.

It is understood that the drawings are for illustration only and are not limiting.

### DETAILED DESCRIPTION OF THE DRAWINGS

After their initial issue, securities instruments, such as stocks and other equity securities, are typically bought, sold, traded or exchanged in the secondary securities market on organized securities exchanges. The New York Stock Exchange (“NYSE”) is an example of an organized securities exchange where the owners of stocks and other equity securities can sell their securities and individuals interested in purchasing stocks or other equity securities can purchase securities.

### Exemplary System

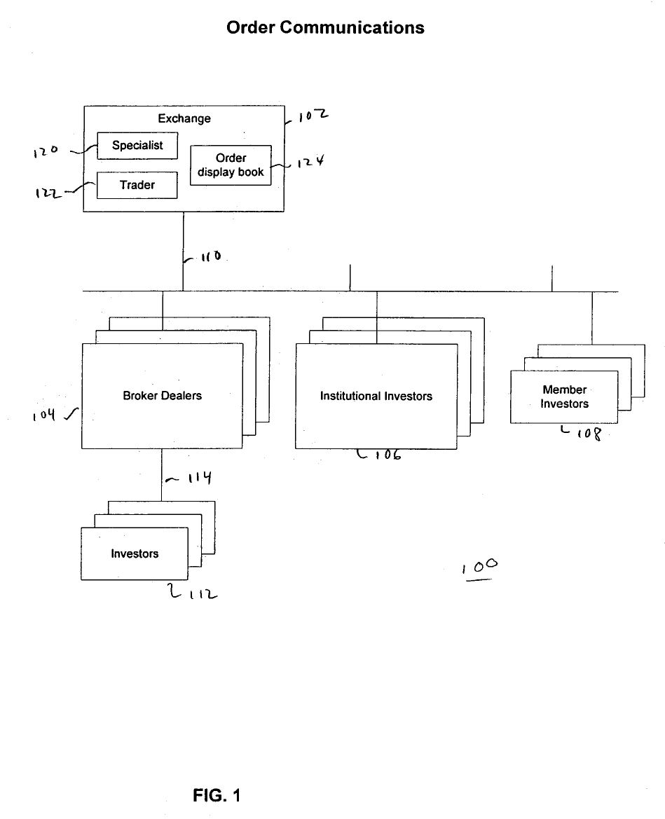

As illustrated in FIG. 1, a trading system 100, such as found on the NYSE, includes an auction exchange 102, with an electronic connection 110 to member broker dealers 104, member institutional investors 106 and members of the exchange 108 as individual investors. Investors 112, who are not members of exchange 102 have an electronic connection 114 to member broker dealers 104. Electronic connections 110, 114 allow transmission of trade orders for securities that are listed on exchange 102, and also allow transmission of acknowledgments and trade confirmations upon completion of the trade. These communication transmissions are elements of a securities transaction.

To effect a transaction, electronic trading orders, transmitted over connection 110 are received by specialist 120 for execution. Some of those orders are limit orders and are entered into the specialist's limit order display book 124, where the specialist can view them.

On exchange 102, floor traders 122 participate in the floor auction as managed by designated specialists 120. Floor traders 122 can also enter orders electronically into the specialist's limit order display book using wireless handheld devices (not illustrated) or using order entry terminals (not illustrated) that are located near or on the auction floor. It is understood that there are many additional components that are part of the electronic order transmission and confirmation system that are not illustrated in the figure. It is also understood, but not illustrated, that multiple computers make up parts of system 100, with the computers including central processor units (CPU), memory (RAM and ROM), data storage, removable data storage media, input/output devices and ports, system/data busses, wired and wireless local area networks (LAN) and wide area networks (WAN), display devices and network interfaces.

### Designated Specialist

To provide structure and order to the securities trading process, some organized exchanges have a single specialist designated for each listed security. This designated specialist 120 serves as an intermediary in the trading of that particular security and one of the responsibilities of the specialist is to create and maintain an orderly and liquid market for the security. The NYSE is an example of such a securities exchange.

### Order Types

There are many order types that are entered and executed on exchange 102. One order type is a limit order, where the order includes a fixed price. Unless the auction market reaches that limit order price, the order will not execute. Another order type is a market order, where the order price is not fixed and the price of the trade is governed by the price that is set on the auction floor at the time the market order reaches the floor and is executed. Both of these order types, in addition to many more order types, can be electronically transmitted to the specialist from locations off the auction floor, and also from locations on the auction floor.

In an auction market, the sellers are generally attempting to receive the highest price for the sale of securities, and the buyers are attempting to pay the lowest price for the purchase of securities. The supply and demand for the securities, as well as the respective interest on each side of the trade in buying and selling will determine the price for each trade.

### Specialist's Limit Order Display Book

On the NYSE, there is a single specialist 120 designated for each listed security. Each specialist 120 may be the designated specialist for more than one stock. To assist the specialist in effectively monitoring the market and interest in each of their assigned stocks or securities, the specialist has access to and maintains a limit order display book 124, where limit orders for a security are available for review and execution by the specialist. In most circumstances, the orders for each security are organized or sorted first by price and then by time, with the respective number of shares or size at each price. For convenience, orders at the same price, but entered at different times are often aggregated into a single display entry at one price in the specialist book.

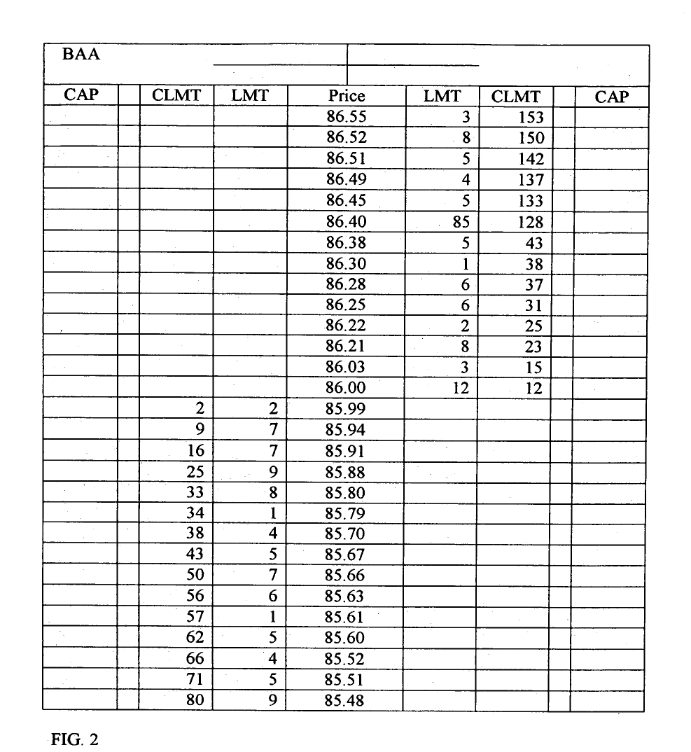

An example display of an electronic order book (124) is illustrated in FIG. 2. In this example, limit orders for a stock with trading symbol “BAA” are sorted by price with associated order size at each price. For example, the display shows limit orders priced between $86.55 and $85.48. The orders at the top of the display, with higher prices, are orders to sell shares of BAA stock. The orders at the bottom of the display, with lower prices, are orders to buy shares of BAA stock. There may be other orders that are priced outside the values that are displayed on the limit order book, so the display may not show all limit orders. The number of round lots (one round lot=100 shares) at each indicated price is provided in the column labeled “LMT” as an abbreviation for limit.

The best price that a prospective buyer is willing to pay for the security is frequently called the best or highest bid, while the best price that a prospective seller is willing to receive for the security is frequently called the best or lowest offer. The difference between the best bid and the best offer is the spread. For a particular security, the best bid is lower than the best offer, and together they are called the quote for that particular security. On the NYSE, each side of the quote is typically based on a minimum of one round lot of the security.

As illustrated in FIG. 2, the highest limit order bid price that is visible on the display book is $85.99 and the lowest limit order offer price is $86.00. Associated with each of those prices is a size. In particular, two round lots (200 shares) are bid at $85.99, and twelve round lots (1,200 shares) are offered at $86.00. This is the best or inside quote for the stock BAA, and might be displayed as:

| Stock | Best Bid | Best Offer | Size |
|---|---|---|---|
| BAA | 85.99 | 86.00 | 200 × 1,200 |

Historically, although the specialist provided this best or inside quote for each security, the additional information from the specialist limit order display book, such as a list of orders outside the quote, was not generally available to the traders on the floor or provided outside the exchange. This additional information is represented in FIG. 2 by the other limit orders on the display book at prices that are outside the best or inside quote.

As illustrated in FIG. 2, it is also possible to include a cumulative number (“CLMT”) of shares on the bid and offer side of the display book. For example, using the information from the display book, a specialist can see that with the limit orders on the book, and assuming that no other orders get price or time priority, a single investor could purchase 3,000 shares of BAA (30 round lots) at prices ranging from $86.00 up to $86.25. Until fairly recently on the NYSE, this type of information was only available to the specialist.

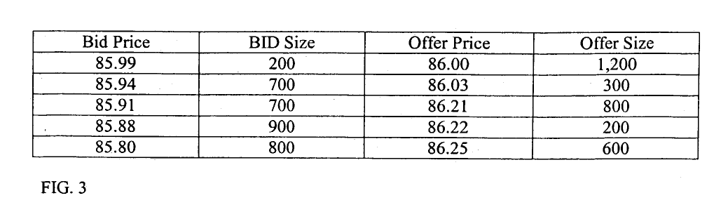

In order for the investor to have access to some of this additional information, some limit order information from the specialist display book is provided on the auction floor of the NYSE and distributed in electronic form outside the NYSE. This information is provided under the name NYSE OPENBOOK, and subscribers to this information receive limit order information from the specialist display book. Using this information, the recipient can provide a display, such as illustrated in FIGS. 2 or 3.

### The Inside Quote

The specialist monitors the orders that come onto the auction floor to buy and sell the security and based on the orders is able to establish the current best sale price for the security, as well as the current best purchase price for the security.

On exchanges with a designated specialist, the quote that is published for a security is generated by or under the control of the specialist, and once the quote is published it is available to traders on the auction floor of the exchange. The published quote is also provided in an electronic format to brokerage houses and other interested individuals for use off the auction market floor of the exchange.

On the NYSE, the published quote is also a firm quote at the price and at the size of the quote. Additionally, on the NYSE the minimum size for the quote is one round lot (100 shares). This means that if a trader is the first to place an order at the quote price, they can always execute a trade for at least one round lot of the security either at the quoted bid price or offer price. If the quote size is more than one round lot, they can execute a trade up to the size of the quote. To distinguish this quote from other quotes that will be described herein, it will be called the “inside quote” or “best quote.”

### Update Of Inside Quote

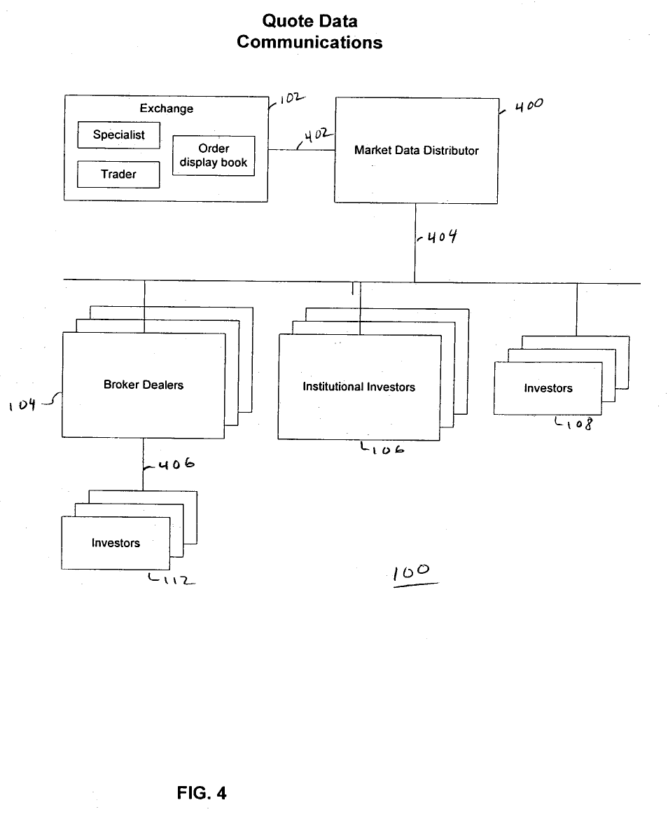

After each trade, there is a determination of whether the bid or offer price of the inside quote has changed. There is also a determination of whether the bid or offer size of the quote has changed. Where the bid or offer price or the bid or offer size of the quote has changed, the new inside quote is generally updated, published and made available on the auction floor. As illustrated in FIG. 4, the inside quote is also provided to market data distributor 400 for transmission to user subscribers 104, 106, 108, 112.

Where the market in a particular security is active, the inside quote may change rapidly, and it can be difficult for an investor to precisely determine the market. Even where the investor has access to the limit orders on the display book, such as illustrated in FIGS. 2 and 3, they will not have a full appreciation for the available market. This is because the orders represented on FIGS. 2 and 3 only include limit orders.

Market orders are not entered on the display book in the same form that limit orders are entered on the display book, and therefore the market orders are not displayed with the limit orders. Another aspect of the market that is not readily reflected in the limit order display book is the firm interest in a security that is expressed by a trader on the floor, or that is expressed by the specialist.

### Quote Data Flow

The paths and data connections illustrated in FIG. 1 for the transmission of orders to the exchange and transmission of trade confirmations to the members/investors are not necessarily the same as the paths and data connections for quote information. Referring to FIG. 4, an example of the paths and connections of system 100 for quote information includes connection 402 between exchange 102 and market data distributor 400. In view of the high volume of quote data and the need for minimal data latency, connection 402 is normally a secure dedicated wide-band or high data rate link (e.g., T-1, T-3, E-1, E-2, E-3). Market data distributor 400 is generally addition to the quote data stream from exchange 102, may receive quote data streams from multiple exchanges and ECN's. Market data distributor 400 packages or re-formats the quote data and provides the consolidated datastream to various users for a fee. Those users include broker dealers 104, institutional investors 106, exchange member investors 108, and ultimately individual investors 112. Together these entities can be considered as user subscribers of the quote data. The path or connection 404 that market data distributor 400 uses is frequently the Internet, or it may be a proprietary network or connection. It is possible for the quote data path connections that are illustrated in FIG. 4 to use the same physical media as the order data path connections illustrated in FIG. 1, but it is not necessary.

### Floor Trader's Interest

Firm interest expressed by a floor trader 122 is like a verbal limit order that is good during the time that the floor trader is standing at the specialist trading station or until the floor trader verbally withdraws their interest. However, firm interest from a floor trader is not entered on the display book unless the floor trader writes it down and hands it to the specialist. When that happens, the floor trader's firm interest becomes a limit order on the display book and will remain on the book until it is cancelled by the floor trader or it is filled. Once the specialist enters the floor trader's firm interest on the display book, the floor trader can leave the area of the specialist trading post but the limit order will remain on the book.

A floor trader may not want to have a large limit order entered on the display book, where other traders can see the order. This could be the case where the trader has a large order to fill, does not need to fill the order immediately and wants to get the best prices on the order. By handling the order as part of the auction floor crowd, the trader can take advantage of the auction market and follow the market while executing the order, but avoid having the order posted on the display book where others located on and off the floor would be able to see the order. This gives a certain level of confidentiality to the order size and order price.

### Specialist's Interest

Just as a floor trader may have firm interest at a certain price and size that is not reflected on the specialist's limit order display book, so too, specialist 120 may have interest at a certain price and size, which is not reflected on the limit order display book. However, other than entering specialist interest at the inside quote, as discussed elsewhere, the specialist's interest is not presently entered on the limit order display book.

In one of their roles, the specialist monitors the respective size and interest on each side of the inside quote for a security. When the size on one side of the inside quote goes to zero, that means that there are no longer any orders at that price. The next best price on that side of the inside quote will constitute the respective bid or offer, and the spread becomes larger. To offset this, the specialist in their role as a market maker, may provide price and size where needed to narrow the spread and maintain a liquid market for the security. Price and size from interest on either side of the inside quote might also come from a floor trader instead of or in addition to the specialist.

### A Typical Securities Transaction

The example below will describe a typical securities transaction on the NYSE. For a more detailed understanding of all of the rules and procedures of the NYSE, a person of ordinary skill would know to refer to New York Stock Exchange GUIDE, Commerce Clearing House (1984 with updates), the disclosure of which is incorporated herein by reference. First, investor 112 places an order with a NYSE Member Broker Firm 104 to buy or sell shares of an NYSE listed company. The NYSE Member Brokerage Firm checks the customer's account and enters order details. The member brokerage firm stores the order in its order match system, and then transmits the order to the NYSE trading floor 102, either computer to computer or in some cases by telephone.

At the NYSE, the Common Message Switch/SuperDot (CMS/SuperDot) stores the order and then, based upon the order details and programmed parameters, either routes the order to a broker's booth or directly to the trading post specialist for the stock.

If the order is routed to the broker's booth, then at the broker's booth on the Exchange floor, the brokerage firm's clerk receives the order electronically (on a display screen) or by telephone (and then enters it onto the screen). The firm's clerk contacts the firm's floor broker by paging, or by wireless telephone, to alert him/her that new orders have arrived. The order may be wired, phoned or physically picked up. The brokerage firm's floor broker then sends the order to the specialist trading post, where trading in that stock takes place to compete with other brokers in the auction market crowd for the best price for the customer and make the trade. The order may be sent to the broker at the trading post by paper, or by using a handheld device.

Alternatively, if the member brokerage firm routes the order to the trading post specialist for the stock, then at the trading post on the Exchange floor, the order appears on the specialist's display book screen 124, which is an order management system. Although there may be other orders on the display book that could be matched with the new order (if the new order is a limit order), the specialist generally exposes all orders received on the display book that are at, better or within the current quote to the auction market crowd and makes the trade, seeking price improvement for the customer whenever possible.

On the NYSE, most orders are exposed to the floor auction for price improvement. Price improvement allows floor traders to compete for. trades by providing prices that are within the inside quote. Although this is a form of interest from the floor traders, the floor traders on the NYSE do not express this interest to the specialist before an order is exposed to the floor for price improvement. If the floor trader did express this interest to the specialist before an order is exposed to the floor for price improvement, the expression of interest would become one side of a new inside quote. The reason is that NYSE requires interest by a floor trader to be an expression of firm interest at a price and size. As such, the expression of firm interest is treated like a limit order, although it is not entered on the specialist's limit order display book. If the specialist receives such a firm expression of interest from a floor trader, and the price is within the current inside quote, that interest must become one side of the inside quote.

Regardless of how the order is delivered to the floor, after the trade, a transaction report is sent to the originating brokerage firm (buying and selling). Once the trade is complete, reports reflecting the trade are also sent to Consolidated Tape Displays world-wide, and to the clearing operations.

Also after the trade is complete, post trade processing matches buyers and sellers. This comparison process takes place almost immediately, and is followed by a 3 -day clearance and settlement cycle at which time transfer of ownership (shares for dollars or vice versa) is completed via electronic record keeping in the depository.

At the member brokerage firm, after the trade is completed, the transaction is processed electronically, crediting or debiting the customer's account for the number of shares bought or sold.

Finally, shortly after the trade is complete, the investor receives a trade confirmation from his/her member brokerage firm. If shares were purchased, the investor's account is charged. If shares were sold, the investor's account is credited with the proceeds.

### Exemplary Method

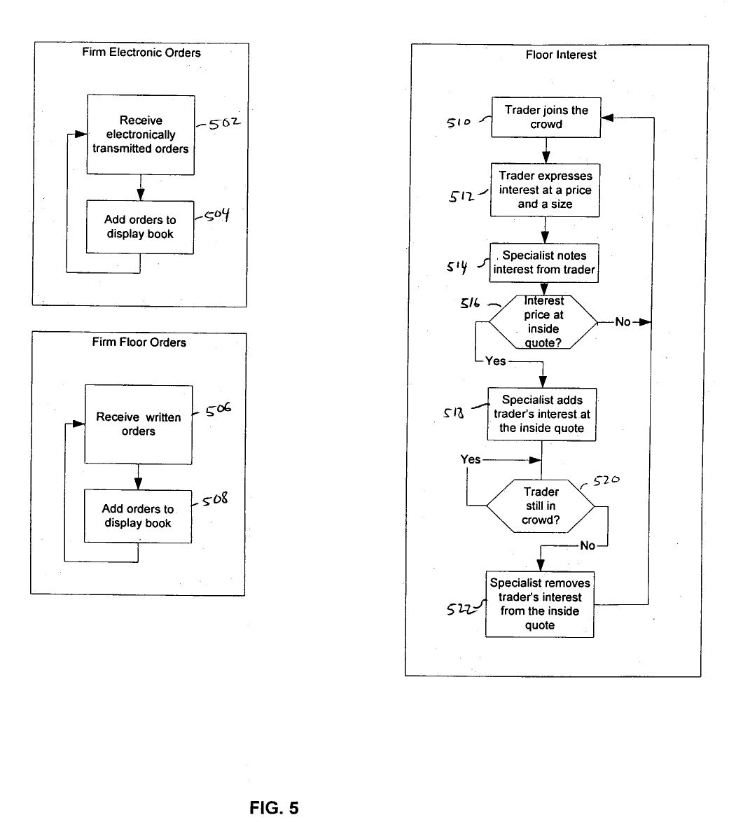

For system 100, FIG. 5 illustrates some of the steps for entry of electronic orders, written orders from floor traders, and firm interest from the floor trader. Where an order is a limit order and is not immediately executable, it will be displayed on the limit order display book, as illustrated in FIG. 2. Where an order is potentially available for immediate execution, such as with a market order, it is normally not displayed on the limit order display book.

For orders that are electronically transmitted to the specialist display book, an order is received at step 502, and at step 504, the order is added to the display book. These electronic orders may originate with individual investors 112 through broker dealers 104, they may originate with member institutional investors 106, or they may originate with member investors 108. A floor trader 122 can also forward an electronic order using a wireless handheld device or enter an order at an order entry terminal on the auction floor.

For written orders that are provided by the floor trader to the specialist, an order is received at step 506, and at step 508, the specialist or an assistant at the trading post adds the order to the display book.

As long as electronic orders for a security are transmitted to exchange 102, the process illustrated in steps 502 and 504 is almost continuous. The process illustrated in steps 506 and 508 may be less frequent if floor traders write few orders.

With steps 502, 504, 506 and 508 occurring in the background, the specialist on the trading floor manages trading of securities at the trading post. At step 510, a floor trader joins the crowd on the auction floor. Assuming that the floor trader has orders for execution that they do not enter electronically, then at step 512 the floor trader may verbally express their firm interest in the security to the specialist. The expression of firm interest from the floor trader includes both a price and a size. Of course, the floor trader is not required to verbally express firm interest for any of their orders.

At step 514, the specialist notes the floor trader's firm interest, and at step 516 the specialist determines whether the price of the floor trader's firm interest is at either the bid or offer price of the current inside quote.

If the floor trader's firm interest is at either the bid or offer price of the current inside-quote, then at step 518 the specialist includes the floor trader's firm interest in the respective size of the inside quote. As an example, if the display book before the floor trader joins the crowd is as illustrated in FIG. 2, then the inside quote is:

| Stock | Best Bid | Best Offer | Size |
|---|---|---|---|
| BAA | 85.99 | 86.00 | 200 × 1,200 |

If a floor trader joins the crowd and expresses firm interest at $85.99, for 500 shares, then the specialist will change the inside quote to:

| Stock | Best Bid | Best Offer | Size |
|---|---|---|---|
| BAA | 85.99 | 86.00 | 700 × 1,200 |

The floor trader's firm interest in 500 shares at $85.99 will remain part of the inside quote until: 1) the trader leaves the floor auction crowd, when the specialist will remove the trader's firm interest from the inside quote (steps 520 and 522), or 2) an order to sell at least 700 shares is received (e.g., a market order, or a limit order priced at $85.99 or less) and executed against the 200 limit order shares and the 500 shares of firm interest from the floor trader.

If at step 516, the floor trader's firm interest is not at either the bid or offer of the inside quote, the specialist notes the trader's firm interest, but there will be no reflection of the floor trader's firm interest on the order display book or the inside quote.

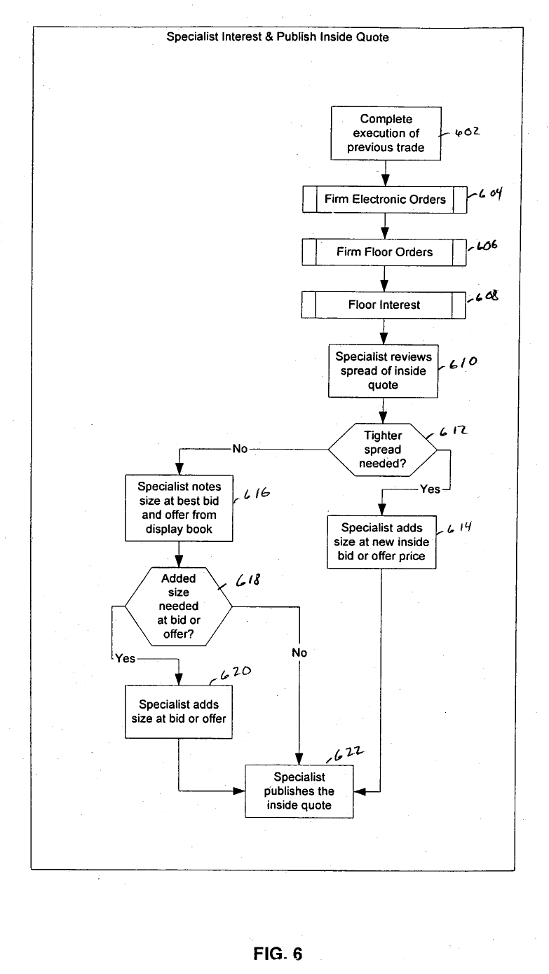

FIG. 6 illustrates the process for update of the inside quote, which generally occurs between each trade. At step 602, the specialist completes the actions required by the previous trade. At step 604, the entry of electronic orders, as illustrated at steps 502, 504 of FIG. 5 occurs. At step 606, the entry of written orders, as illustrated at steps 506, 508 of FIG. 5 occurs. At step 608, firm interest from floor traders and addition of that firm interest to the inside quote, as illustrated at steps 510 - 522 of FIG. 5 occurs.

At step 610, the designated specialist for the security reviews the spread of the inside quote. One of the roles of the designated specialist on the NYSE is to maintain an orderly and liquid market for each of their assigned securities. One aspect of a liquid market is a small spread between the bid and offer price of the inside quote. If the spread becomes too wide, it will be more difficult for buyers and sellers to come to a mutual agreement on price in the auction. One of the reasons that the spread may become larger is where there is strong pressure on one side of the market. In those cases, the number of bids or offers on the opposite side may decline. The specialist, with their experience in each of their designated securities, will have a feel for whether the spread has become too large, causing the market for that security to become less liquid. In that case, at step 614, the specialist will add size at a new price to the inside quote to narrow the spread. The size that the specialist adds at a new price to narrow the spread is the specialist's “interest” reflected as part of the inside quote.

If the specialist decides at step 612 that the spread of the inside quote is satisfactory, then at steps 616, 618, the specialist decides whether the size on each side of the inside quote is satisfactory.

If additional size is needed on the bid or on the offer side, then at step 620, the specialist adds size to that side.

Once the specialist is satisfied with the spread and size of the inside quote, then at step 622, the inside quote is published. Once the quote is updated and published, the specialist processes and executes the next trade, and the process begins again at step 602.

The discussion above and illustrations indicate that the specialist takes an active role in managing the inside quote and makes a number of different decisions between each trade in the course of updating and publishing the inside quote. However, to relieve the specialist of some of the workload, various decision steps may be automated, and use pre-determined or pre-set parameters in order to auto-quote the security. It is only when the market falls outside those pre-determined or pre-set parameters that the specialist must physically take action as illustrated in FIG. 6. For example, the specialist may set an acceptable spread parameter and as long as the spread is within that parameter, step 612 is performed automatically. Similarly, the specialist may set an acceptable size parameter and as long as the size on each side of the inside quote is within that parameter, step 618 is performed automatically. If the orders on the display book and market are such that it automatically passes steps 612 and 618 (i.e., both answers are “no”), publication of the quote at step 622 may be totally automatic without any interaction from the specialist.

### Exemplary Order Execution

The floor trader with a large order to fill would like to have some idea at what price they can execute the order. The limit orders on the display book can provide information on the likely worst case price for a large order, assuming that the trader gets time priority and their orders execute against the limit orders on the book.

Using FIG. 2 in a simplistic example, without considering price improvement from the floor, if a trader wants to buy 5,000 shares of BAA, they know that the inside quote offer price is $86.00 and the size at that price is 12 round lots (1,200 share). If they submit a market order and get priority they can buy all 1,200 shares at $86.00. They still need 3,800 shares to fill their order, and they can submit another market order for 300 shares and get them at $86.03. The trader can continue to place market orders to execute against the limit orders on the book up to $86.38 for 500 shares (4,300 shares total), and the final market order of 700 shares (to get to the total 5,000 shares) would execute at $86.40. Although the described scenario is possible, it is not likely that a trader would do this. The market is very dynamic and other traders would very likely enter or leave the market before a trader could execute all of the required trades.

Alternatively, the trader could place a single market order for 5,000 shares and again, if they get time priority and without considering price improvement from the floor, the order would execute against the limit orders on the display book at the prices shown on the book.

The trader knows that these scenarios might be the worst prices they can expect.

The first 1,200 shares of the 5,000 share order would cost $86.00 each and the last 700 shares of the 5,000 share order would cost $86.40 each.

In actuality, the cost to execute an order to buy 5,000 shares might be significantly less than the limit orders on the display book imply. In another example, when the trader places the same market order for 5,000 shares, the specialist notes the existing inside quote offer price at $86.00 for 1,200 shares and exposes 1,200 shares of the 5,000 share market order to the auction floor for price improvement. With the spread of the inside quote only one cent, there is no price improvement available from the floor, and the first 1,200 shares of the order executes at $86.00. The next part of the order (3,800 shares) is exposed to the auction floor at various prices for price improvement over the limit orders on the display book. In view of the $0.40 difference between the best offer and the last limit order needed to fill a 5,000 share order from the display book, it is very likely that another floor trader, who is interested in selling shares will want to sell shares at prices that are better than the limit orders on the book. In this way, the total cost of the 5,000 share order is likely to be less than the orders shown on the display book would tend to indicate. In fact, it is possible that a floor trader would be willing to sell or has expressed firm interest in selling 4,000 shares of BAA at $86.05, but does not want the exact price and size of that interest to appear on the limit order display book. In this case, the first 1,200 shares of the 5,000 share order would cost $86.00, the next 300 shares of the order would cost $86.03, and the last 3,500 shares of the order would cost $86.05.

In the 5,000 share example trades above, after executing 1,200 shares at $86.00 and 300 shares $86.03, if there was no other trader interested at $86.05 or a better price, the specialist could take 3,500 shares at $86.05.

In these examples, the firm interest from floor traders or from the specialist provides a much better view of where the market really is. However, as illustrated in FIG. 2, the display book available to investors only shows limit orders. Firm interest from the floor or from the specialist is not reflected on the display book.

### NASDAQ And Other ECNs

Some organized exchanges, such as the NASDAQ, and some electronic communications networks (“ECNs”) have one or more specialists or market makers for a listed security instead of only one designated specialist for each listed security. Each of these market makers can provide their own best bid and best offer for the security. On the NASDAQ, when the best bids and offers from these multiple market makers are electronically combined, the overall best bid and the best offer together constitute the “inside quote.” This is also referred to as the National Best Bid and Offer (“NBBO”). On this type of exchange, it is possible for the bid and offer sides of the inside quote to come from different market makers.

For the purposes of this description, these types of exchanges can be collectively referred to as floor-less auction markets because while the exchange functions as an auction market for the listed securities, there is no requirement for a physical floor crowd to gather and participate face-to-face in the auction market while providing price improvement.

The NASDAQ is an example of a floor-less auction market, which is computerized and does not require a central trading floor. It has an open architecture to allow different electronic trading systems or ECNs to connect to the NASDAQ network and compete with each other for trades. There are over 300 market makers participating with NASDAQ, who post their bids and offers on the NASDAQ network. According to published reports, there are over 10 market makers for the average stock that is listed on the NASDAQ.

The NASDAQ network also operates in conjunction with PRIMEX TRADING, where traders can express their interest electronically. According to the PRIMEX TRADING web site, this interest is anonymous and is at prices that are equal to or better than may be available in the NBBO.

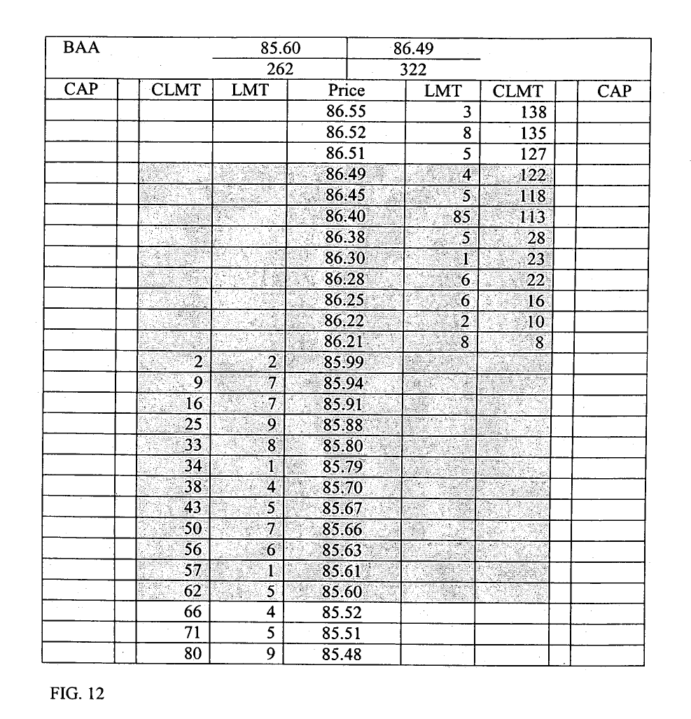

FIG. 12 illustrates how limit orders for BAA might appears on NASDAQ. As illustrated, the inside quote (or NBBO) is:

| Stock | Best Bid | Best Offer | Size |
|---|---|---|---|
| BAA | 85.99 | 86.21 | 200 × 800 |

With the NASDAQ PRIMEX auction system, Investor E, who is interested in selling 100 shares of BAA, expresses their anonymous interest to sell at NBBO+0.04 (i.e., $86.21 −$0.04 =$86.17). One second later, investor F who is also interested in selling 100 shares of BAA expresses their interest at NBBO+0.05 (i.e., $86.16). One second later, investor G expresses their interest in selling BAA at NBBO +0.04 (i.e., $86.17). PRIMEX calls this type of interest a Predefined Relative Indication (PRI) because the price is relative to the NBBO. In this example, investor F has price priority over investors E and G because investor F has expressed interest at a better price than either investor E or G. Investor E does not have price priority over investor G because they have each expressed interest at the same relative prices, but investor E has time priority over investor G because the expression of interest from investor E was entered before the expression of interest from investor G. The same type of example would apply to expressions of interest to buy where the interest is priced relative to the NBBO. As this example indicates, the interest expressed by investors in the NASDAQ PRIMEX system is always within the NBBO.

Although there are significant differences between a live auction market like the NYSE and a floor-less auction market like the NASDAQ, the anonymous interest that an investor expresses with the existing NASDAQ PRIMEX auction system is somewhat analogous to price improvement on the auction floor of the NYSE.

### Liquidity Quote

The liquidity quote is a second quote, provided in conjunction with the inside quote. Together with the inside quote, the liquidity quote provides additional information on the state of the market for a particular security.

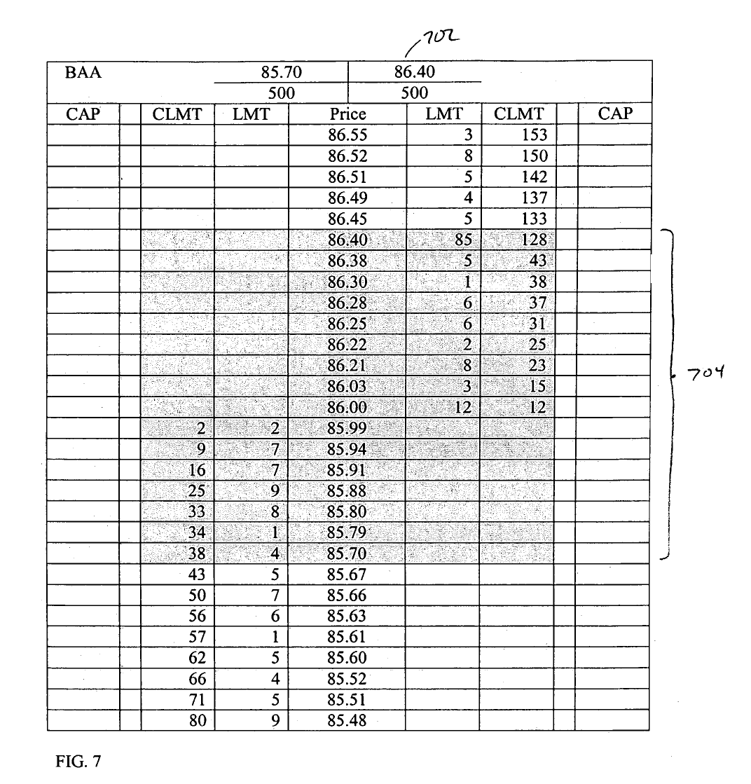

Referring to the specialist's limit order display book at FIG. 7, the same limit orders, previously seen on FIG. 2 are displayed. The specialist knows that shares of BAA stock have been trading near $86.00 and the specialist also knows that in the past, floor traders have generally expressed firm interest within about $0.30 or $0.40 of the inside quote. Therefore, to capture some of this firm interest from the floor traders, the specialist sets the liquidity quote bid at $85.70, and the liquidity quote offer at $86.40. The precise price points that the specialist selects are generally discretionary, and the specialist uses their experience in the market for each security in setting the liquidity quote. As noted in the example, the specialist can set the liquidity bid and offer at different price distances from the inside quote. In this example, the liquidity bid price is $0.29 below the inside bid, and the liquidity offer price is $0.40 above the inside offer price. The specialist will generally set the initial liquidity price points at the beginning of each trading day. At the same time, the specialist sets bunching parameters. Over the course of the trading day, the specialist will adjust the liquidity quote price points as the market moves. The specialist may also adjust the bunching parameters due to changes in the market. The particulars of the bunching parameters and how they relate to the liquidity quote will be described later in greater detail.

Having set the liquidity quote at $85.70 and $86.40, the cumulative limit order size on the display book, corresponding to the liquidity quote is 3,800 shares (bid) and 12,800 shares (offer) respectively. If the specialist wanted to publish this information as the liquidity quote it would be:

| Stock | Liquidity Bid | Liquidity Offer | Size |
|---|---|---|---|
| BAA | 85.70 | 86.40 | 3,800 × 12,800 |

Assuming that the investor is already receiving limit order information from the specialist display book, through systems such as NYSE OPENBOOK, then providing a liquidity bid and offer, which includes only the cumulative order size information from the specialist limit order display book does not provide significant additional information to the investor.

However, as previously described, and except for very specific circumstances, the firm interest expressed by floor traders or the specialist at a particular price and size is information that is generally not available on the specialist's limit order display book. As illustrated in FIG. 5 and discussed above, those very specific circumstances occur where the firm interest is at the bid or offer price of the inside quote, and then the firm interest is reflected on the inside quote.

In the example illustrated in FIG. 7, there are 3,800 shares in limit orders priced at or between the inside quote bid price of $85.99 and the liquidity quote bid price of $85.70. If floor trader “A” expresses firm interest in BAA to the specialist for 10,000 shares at $85.85, trader “B” expresses firm interest in BAA to the specialist for 20,000 shares at $85.80, and trader “C” expresses firm interest in BAA to the specialist for 16,200 shares at $85.75, there is a total of 50,000 shares (3,800+10,000+20,000+16,200) in firm limit orders or firm interest available at or between $85.99 and $85.70. Similarly, if floor trader “D” expresses firm interest in BAA to the specialist for 37,200 shares at $86.30, there is a total of 50,000 shares (12,800+37,200) in firm limit orders or firm interest available at or between $86.00 and $86.40. In such a case, the liquidity quote would be:

| Stock | Liquidity Bid | Liquidity Offer | Size |
|---|---|---|---|
| BAA | 85.70 | 86.40 | 50,000 × 50,000 |

On the specialist display book the liquidity quote is represented at 702. To assist the specialist in visualizing the liquidity quote, the boundaries on the display book are also visually marked with a different color or different shading (704).

The information contained in the liquidity quote is more information than is available from only the limit orders reflected on the specialist's limit order display book. With the liquidity quote, investors and traders know that a buy or sell order for up to 50,000 shares can be executed at or possibly within the price of the liquidity quote. Whether they will be able to execute such an order will depend on whether they can get price and time priority over all other orders.

Although the liquidity quote provides additional information on the market and insight into firm interest that is expressed at specific prices and size between the inside quote and the liquidity quote, the liquidity quote does not reveal precisely where that firm interest is or how the firm interest might be distributed. In this way, the confidential aspect of larger orders that are not on the limit order display book is preserved, but the information that such firm interest exists is available to other investors and can be used as they make decisions.

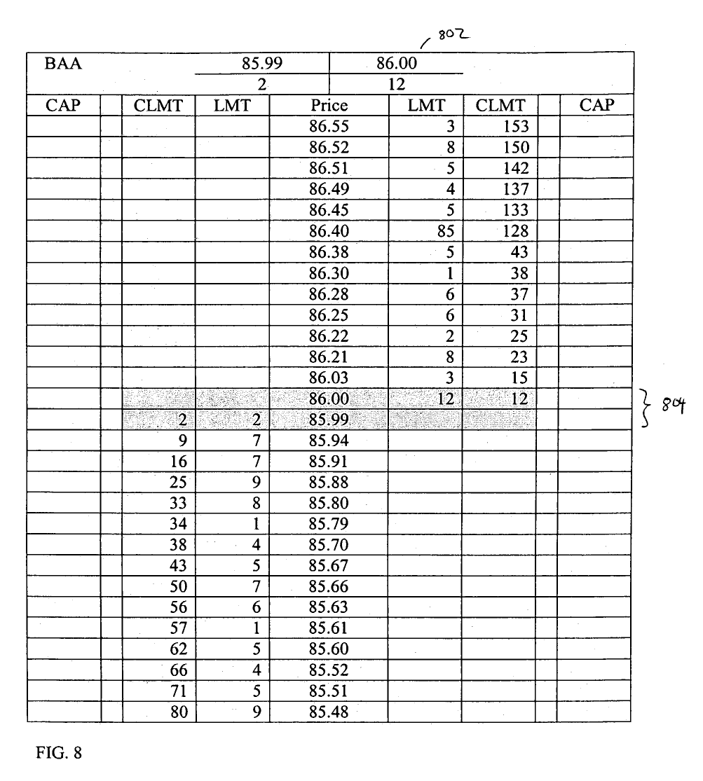

It is also possible that the specialist decides to publish the liquidity quote at the same price as the inside quote. For example, if there is minimal or no firm interest from floor traders that is not already reflected on the limit order display book, the liquidity quote would provide no added value to investors and traders. Similarly, if the firm interest from floor traders is far from the inside quote, the specialist may decide that a large spread in the liquidity quote has no value and therefore they may publish the liquidity quote at the inside quote. FIG. 8 reflects such a circumstance where the liquidity quote, 802, is the same as the inside quote and the liquidity quote boundaries 804 include only the inside quote.

As indicated, the inside quote may change rapidly in price and size. Even where the market for the security is relatively flat over the course of a day, there will be up and down movements and the interest on each side of the inside quote will increase and decrease as trades execute. For traders, this rapid change of the inside quote shows where small size trades will execute, but it does not provide insight into where a larger trade will execute. To accommodate this information need, the trader generally wants a liquidity quote with bid and offer prices that do not change as frequently as the inside quote prices. Additionally, they generally want the size of the liquidity quote to remain somewhat stable in time as well.

When the specialist sets the liquidity quote bid and offer prices, those prices are likely to remain unchanged until the market for the particular security moves in one direction or another.

In the example above, the spread of the liquidity quote for BAA is $0.70 and the stock price is $86.00. Therefore, the spread of the liquidity quote is less than one percent of the stock price. For stocks that are not extremely volatile, a spread of this size in the liquidity quote may provide a sufficient buffer around the inside quote for a few hours of trading, and the specialist will not need to update the liquidity quote price until the market for BAA moves up or down.

Over the course of a trading day, the specialist may decide that the liquidity quote prices need to be changed because the market has moved away from the initial quote, or because trader interest has moved and the current liquidity quote does not adequately reflect the new interest. In these and other instances, the specialist can change the liquidity price points as they see necessary. The liquidity quote prices will generally not change as quickly as either the inside quote prices or the liquidity quote size.

### Floor Trader's Firm Interest

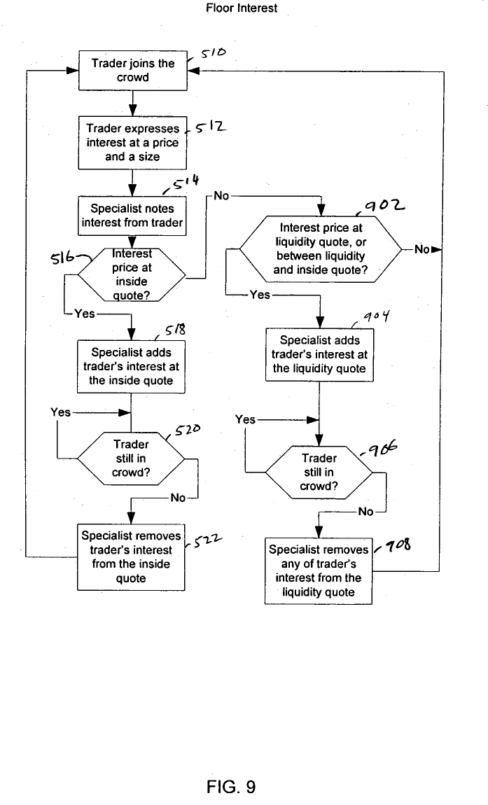

Referring now to FIG. 9, with the instant invention, the steps to capture the floor trader's firm interest are similar to the steps illustrated in FIG. 5. Beginning at step 510, a floor trader joins the auction market crowd.

Again, assuming that the floor trader has orders for execution that they do not want to enter electronically, then at step 512 the floor trader expresses their firm interest in the security to the specialist. Again, the expression of firm interest from the floor trader is not required, but includes both a price and a size when it is expressed.

At step 514, the specialist notes the floor trader's firm interest, and at step 516 the specialist determines whether the price of the floor trader's firm interest is at either the bid or offer price of the current inside quote.

If the floor trader's firm interest is at either the bid or offer price of the current inside quote, then at step 518 the specialist includes the floor trader's firm interest in the respective size of the inside quote. As an example, if the display book before the floor trader joins the crowd is as illustrated in FIG. 2, then the inside quote is:

| Stock | Best Bid | Best Offer | Size |
|---|---|---|---|
| BAA | 85.99 | 86.00 | 200 × 1,200 |

If a floor trader joins the crowd and expresses firm interest at $85.99, for 500 shares, then the specialist will change the inside quote to:

| Stock | Best Bid | Best Offer | Size |
|---|---|---|---|
| BAA | 85.99 | 86.00 | 700 × 1,200 |

The floor trader's firm interest in 500 shares at $85.99 will remain part of the inside quote until: 1) the trader leaves the floor auction crowd, when the specialist will remove the trader's interest from the inside quote (steps 520 and 522), or 2) an order to sell at least 700 shares is received (e.g., a market order, or a limit order priced at $85.99 or less) and executed against the 200 limit order shares and the 500 shares from the floor trader.

If at step 516, the floor trader's firm interest is not at either the bid or offer of the inside quote, then at step 902 the specialist notes whether the trader's interest is outside the liquidity quote or is between the inside quote and the price set for the liquidity quote.

If the firm interest is outside the liquidity quote, nothing further happens with regard to that interest. Alternatively, if at step 902 the firm interest is at the liquidity quote or between the inside quote and the liquidity quote, then at step 904 the specialist adds the floor trader's firm interest to the liquidity quote.

At step 906, the specialist determines whether the floor trader remains in the auction crowd, and if the floor trader leaves the crowd, then at step 908 the specialist removes the floor trader's firm interest from the liquidity quote.

### Bunching Parameter

While it may be possible to leave the bid and offer prices of the liquidity quote at the same prices for a period of time, the size on each side of the liquidity quote generally requires a more frequent update. However, the frequency of the liquidity quote size update is generally less than the frequency of the inside quote update. Use of a bunching parameter can play a role in determining when to update the liquidity quote size.

In the simplest form, the bunching parameters are numeric thresholds for update. There is a bunching parameter for the bid side and a bunching parameter for the offer side. Update of the liquidity quote occurs when the number of events on either the bid or offer side reaches the bunching parameter. An update of the liquidity quote resets the event counters to zero. Some of the types of trading transactions that are considered events include orders, order cancels and trades.

An event occurs when there is a change in the number of orders on the specialist's limit order display book or firm interest that is priced equal to or between the inside quote price and the liquidity quote price. The following example illustrates how different events are considered with relation to the bunching parameters.

The bid and offer bunching parameters are each set at 5000 events, and the event counters for the bid and offer sides start at zero. The specialist's limit order display book is as illustrated in FIG. 2, and the inside quote and liquidity quote are:

| Stock | Best Bid | Best Offer | Size |
|---|---|---|---|
| BAA | 85.99 | 86.00 | 200 × 1,200 |
| Stock | Liquidity Bid | Liquidity Offer | Size |
| BAA | 85.70 | 86.40 | 50,000 × 50,000 |

The specialist receives a market order to sell 2000 shares. The specialist exposes the order to the auction floor for price improvement, but there is none, and the specialist executes the trade against the limit orders to buy on the specialist's limit order display book. The 2000 share trade is executed against the buy limit orders on the book of 200 shares at $85.99, 700 shares at $85.94, 700 shares at $85.91 and 400 shares at $85.88. This trade for 2000 shares causes the event counter on the bid side to increase by 2000 from 0 to 2000, because the trade reduced the number of limit orders to buy priced between the inside quote bid and the liquidity quote bid.

Next, the specialist receives a limit order to buy 1000 shares at $85.91. This order to buy 1000 shares causes the event counter on the bid side to decrease by 1000 from 2000 to 1000 because the order increased the number of limit orders to buy priced between the inside quote bid and the liquidity quote bid.

Before any trades are executed, the specialist receives a cancel of the limit order to buy 1000 shares at $85.91. This order cancel causes the event counter on the bid side to increase by 1000 from 1000 to 2000 because the order cancel reduced the number of limit orders to buy priced between the inside quote bid and the liquidity quote bid.

Next, the specialist receives a market order to sell 4000 shares. The specialist exposes the order to the auction floor for price improvement, but there is none, and the specialist executes the trade against the remaining limit orders on the specialist's limit order display book. The 4000 share trade is executed against the buy limit orders on the book of 500 shares remaining at $85.88, up through the liquidity quote of $85.70. Some of the trade is executed against the firm interest that is reflected in the liquidity quote. This trade for 4000 shares causes the event counter on the bid side to increase by 4000 from 2000 to 6000, because the trade reduced the number of limit orders and firm interest to buy priced between the inside quote bid and the liquidity quote bid.

The bunching parameter on the bid side was set at 5000 events and after the last trade, the event counter reached 6000. This caused the system to recalculate and republish the liquidity quote. At the same time, the event counters on the bid and offer side were both reset to zero.

The bunching parameters also play a role in setting or limiting the specialist's exposure. On the NYSE, both the inside quote and the liquidity quote are firm quotes. This means that if an order comes it at the price and size of either quote, the specialist must stand behind the quote to execute the order. Normally, the specialist will have limit orders on the display book and/or firm interest expressed by a floor trader to fill any order up to the size of the inside quote or the liquidity quote. As explained, some of the size reflected in the liquidity quote comes from limit orders on the specialist limit order display book. The rest of the size reflected in the liquidity quote comes from firm interest that is expressed by floor traders, or from “interest” that is expressed by the specialist. With limit orders and/or firm interest from floor traders for all of the size that is reflected in either quote, the specialist will not be personally liable for any of the size in either quote. However, as the specialist executes orders, if the contra side for any of those order executions comes from the limit order book or from the firm interest that was expressed by a floor trader, then the number of remaining firm orders will necessarily decrease. Since the liquidity quote is a firm quote, unless the specialist updates the liquidity quote to reflect a smaller size, they are in effect increasing their own “firm interest” as reflected in the liquidity quote. The value of the bunching parameter somewhat reflects a buffer of transactions, and therefore the maximum number of shares that the specialist might be liable for if someone places an order against the liquidity quote and the liquidity quote is not regularly updated.

### Specialist's Interest

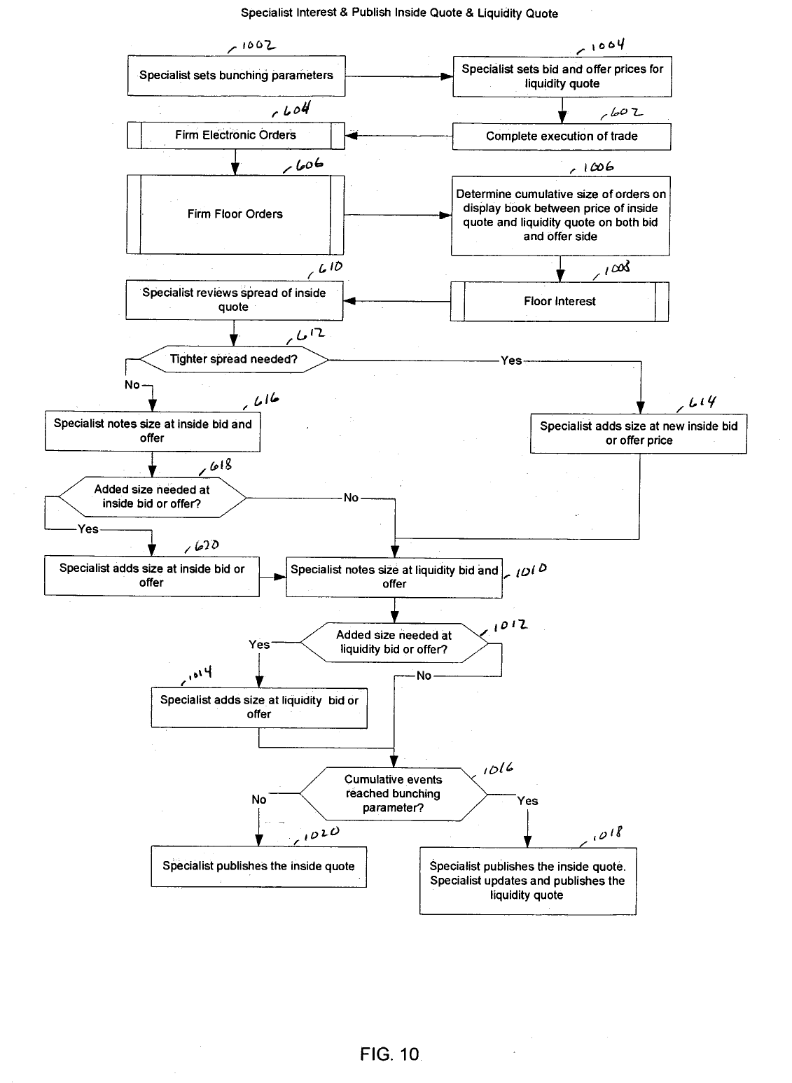

FIG. 10 illustrates many of the steps in an embodiment of the invention. At the beginning of a trading day, at step 1002, the specialist sets the bunching parameters. Also at the beginning of a trading day, at step 1004, the specialist sets the bid and offer prices of the liquidity quote. Normally, the specialist sets the bunching parameters and the liquidity quote prices after opening the stock for trading. During the course of the trading day as the market moves, the specialist will adjust the bid and offer price of the liquidity quote, and may also adjust the bunching parameters.

Although a loop is not illustrated, steps beginning with step 602 occur between each trade. At step 602, the specialist completes the actions required by the previous trade. At step 604, the entry of electronic orders, as illustrated at steps 502, 504 of FIG. 5 occurs. At step 606, the entry of written orders, as illustrated at steps 506, 508 of FIG. 5 occurs.

At step 1006, there is a determination of the cumulative size of limit orders between the inside quote price and the liquidity quote price on both the bid and offer side. These cumulative sizes are the minimum sizes that will be reflected in the liquidity quote.

At step 1008, firm interest from floor traders and addition of that firm interest to the inside quote and liquidity quote, as illustrated in FIG. 9 occurs.

At step 610, the designated specialist for the security reviews the spread of the inside quote. As previously discussed, one of the roles of the designated specialist on the NYSE is to maintain an orderly and liquid market for each of their assigned securities. One aspect of a liquid market is a small spread between the bid and offer prices of the inside quote. If the spread becomes too wide, it will be more difficult for buyers and sellers to come to a mutual agreement on price in the floor auction. One of the reasons that the spread may become larger is where there is strong pressure on one side of the market. In those cases, the number of orders on the opposite side may decline. The specialist, with their experience in each of their designated securities, will have a feel for whether the spread has become too large, causing the market for that security to become less liquid. In that case, at step 614, the specialist will add size at a new price to the inside quote to narrow the spread. The size that the specialist adds at a new price to narrow the spread is the specialist's “firm interest” reflected as part of the inside quote.

If the specialist decides at step 612 that the spread of the inside quote is satisfactory, then at steps 616, 618, the specialist decides whether the size on each side of the inside quote is satisfactory.

If additional size is needed on the bid or on the offer side of the inside quote, then at step 620, the specialist adds size to that side.

Once the specialist is satisfied with the spread and size of the inside quote, then at steps 1010, 1012 the specialist determines whether the size of the bid and offer of the liquidity quote are satisfactory, and if additional size is required, then at step 1014 the specialist adds size at the bid or offer of the liquidity quote. The size that the specialist adds to the liquidity quote is the specialist's “firm interest” reflected as part of the liquidity quote.

Once the size of the bid and offer of the liquidity quote are satisfactory, then at step 1016 the number of events since the last publication of the liquidity quote is compared to the bunching parameter. If the number of events has not reached the bunching parameter, then at step 1020, the updated inside quote is published, leaving the liquidity quote unchanged. Alternatively, if the number of events has reached the bunching parameter, then at step 1018, both the updated inside quote and the updated liquidity quote are published. The event counters are also reset when the liquidity quote is updated. The next trade is executed and the process then begins again at step 602.

### Floor-Less Auction Markets

In the examples above, a designated specialist for each security sets or manages the price and size of the inside quote and the liquidity quote. However, the instant invention is not limited to only such a circumstance.

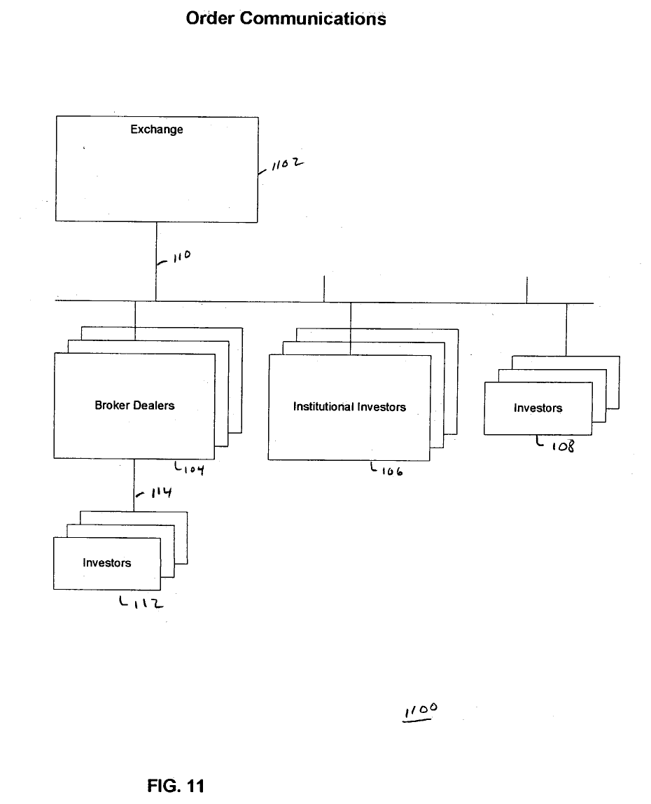

FIG. 11 illustrates an embodiment of a system 1100 of the instant invention with a floor-less auction market. Broker dealers 104, institutional investors 106 and investors 108 have an electronic connection 110 that is used to send electronic orders and receive order confirmation and trade reports from floor-less auction market exchange 1102. Investors 112 forward their orders to exchange 1102 using electronic connection 114 with broker dealers 104. Although not illustrated, exchange 1102 may have connections to other exchanges or ECNs.

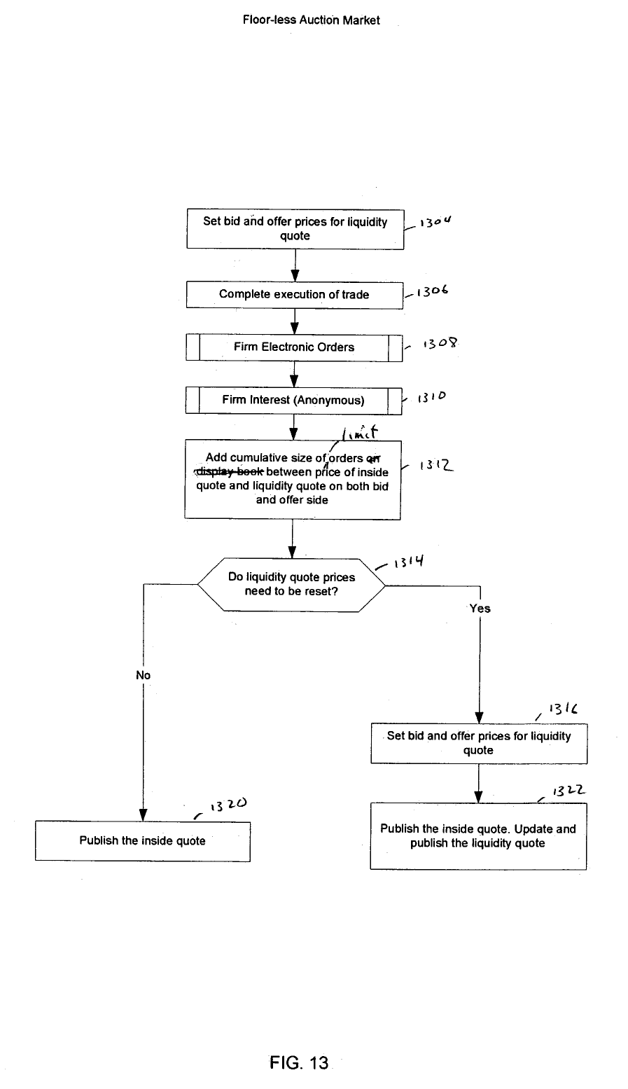

Referring now to FIG. 13 as an example of an embodiment of the instant invention with a floor-less auction market, at step 1304, system 1100 sets a liquidity bid price and a liquidity offer price, which together constitute a liquidity quote. Although an individual market maker may set the liquidity quote prices subjectively using experience, in system 1100 it is more common to automatically set the liquidity quote prices using predetermined price or percentage values that are tied to or based on the inside quote. For example, the liquidity quote can be simply a percent above and below the inside quote. For securities that experience significant market fluctuation, the percentage value can be greater than for securities that have lower fluctuation. The standard deviation of the prices is one measure of the fluctuation.

Once system 1100 or an individual sets the liquidity quote bid and offer prices, then at step 1306, the previous. trade is completed. The method begins a series of steps at step 1306 that repeat during the course of the trading day.

At step 1308, traders and investors enter firm electronic orders such as illustrated in steps 502, 504 of FIG. 5. These orders are generally limit orders.

At step 1310, traders and investors express their firm interest at prices between the liquidity quote prices and the inside quote prices. This expression of interest is a firm expression of interest at a price and size, but the firm interest is not identified to other traders or investors by price and size, or by the name of the trader expressing the firm interest. This technique is similar to the technique used in the PRIMEX TRADING system except that here the firm interest is outside the NBBO. System 1100 receives the firm expression of interest and includes that firm interest in the size that is reflected in the liquidity quote.

As an example referring to the limit orders illustrated in FIG. 12, investor H expresses firm interest to sell 10,000 shares at $86.26. One second later, investor I expresses firm interest to sell 5,000 shares at $86.23, and another second later, investor J expresses firm interest to sell 5,000 shares at $86.26. Investor K expresses their firm interest to buy 20,000 shares at $85.92. As the example indicates, these expressions of firm interest are priced outside the NBBO. None of this firm interest is published as a limit order that is visible to other traders. In this way, the exact price, size and the name of the trader expressing firm interest is hidden or anonymous, but the firm interest is reflected in the liquidity quote.

At step 1312, system 1100 adds the cumulative size of limit orders to the firm interest to get the total number of firm bids and offers.

With the Liquidity Quote prices at $85.60 and $86.49, as illustrated in FIG. 12, (i.e., bid at $85.60 and offer at $86.49) then the cumulative total of limit orders on the book is 6,200 and 12,200 respectively. Adding the cumulative limit orders from the book and firm interest to sell that is expressed by investors H, I, J (total 20,000 shares) and firm interest to buy that is expressed by investor K (total 20,000 shares), the liquidity quote is:

| Stock | Liquidity Bid | Liquidity Offer | Size |
|---|---|---|---|
| BAA | 85.60 | 86.49 | 26,200 × 32,200 |

At step 1314, system 100 determines whether the prices of the liquidity quote bid and offer need to be reset. Once system 1100 sets the liquidity quote bid and offer prices at the beginning of a trading day, the liquidity quote prices are generally not changed unless or until the inside quote moves significantly toward one of the liquidity quote values or the anonymous interest falls outside the liquidity quote bid and offer price and movement of the liquidity quote would capture that anonymous interest. As an example, if the liquidity quote bid is a certain percent below the inside quote bid, then the liquidity quote bid may be changed only when the inside quote bid moves one half of the price distance to the liquidity quote. (e.g., if the inside quote bid price is $85.99 and the liquidity quote bid price is $85.70, the liquidity quote bid price is not changed unless or until the inside quote price reaches $85.85, at which point the system sets a new liquidity quote bid price and a new liquidity quote offer price). Other tests for reset of the liquidity quote prices are clearly envisioned as well.

If the liquidity quote prices need to be reset, then at step 1316, system 1100 resets the prices. The technique used to reset the prices can be the same as the technique used at step 1304 to initially set the prices. The updated inside quote and the updated liquidity quote are then both updated and published at step 1322.

If the liquidity quote prices are satisfactory, then at step 1320, only the updated inside quote is published.

### Order Execution

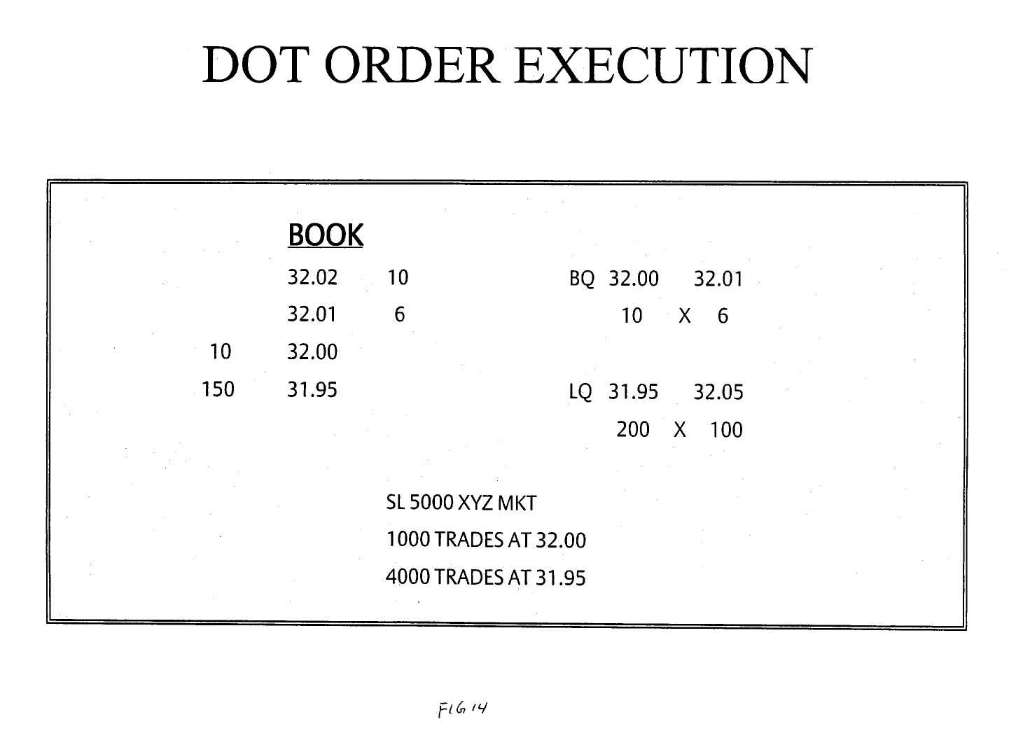

FIGS. 14-18 illustrate order execution in various embodiments of the invention. In FIG. 14, the limit orders on the specialist's limit order display book include 1000 shares to sell at 32.02, 600 shares to sell at 32.01, 1000 shares to buy at 32.00 and 15,000 shares to buy at 31.95. The inside quote is:

| Stock | Inside Bid | Inside Offer | Size |
|---|---|---|---|
| XYZ | 32.00 | 32.01 | 1,000 × 600 |

Floor traders have expressed firm interest on the buy and sell side and the specialist has set the liquidity quote price levels at 31.95 and 32.05 respectively. The liquidity quote is:

| Stock | Liquidity Bid | Liquidity Offer | Size |
|---|---|---|---|
| XYZ | 31.95 | 32.05 | 20,000 × 10,000 |

The specialist receives a DOT order to sell 5000 shares at the market. The specialist trades 1000 shares at the inside bid of 32.00 and trades the other 4000 shares at the liquidity bid of 31.95.

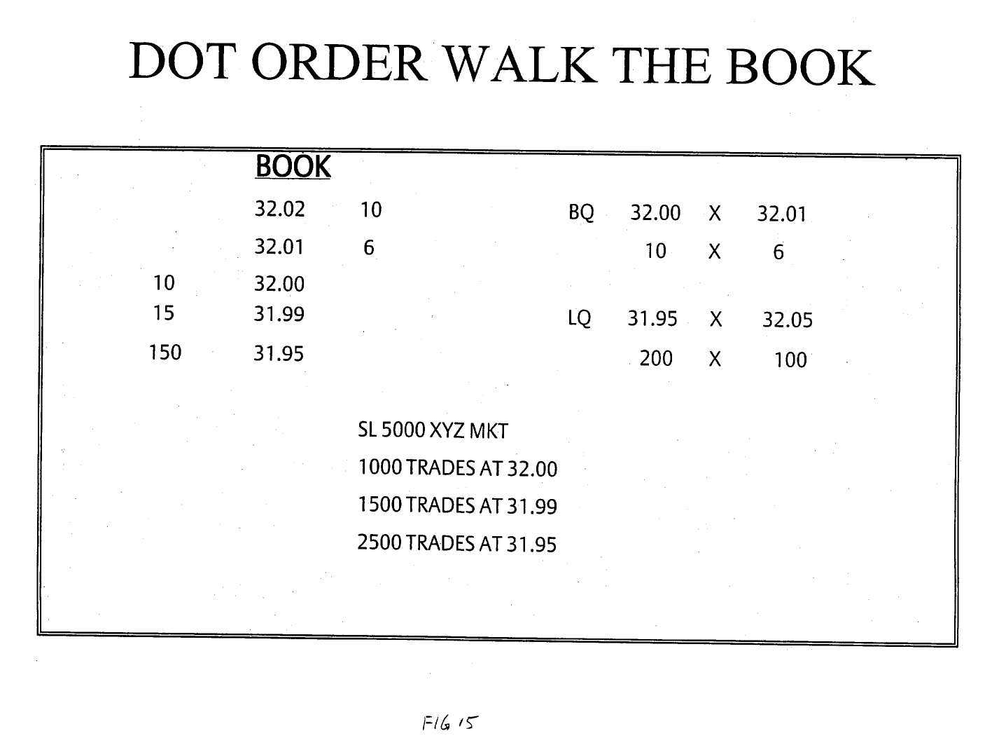

In another example, illustrated in FIG. 15, the limit orders on the specialist's limit order display book include 1000 shares to sell at 32.02, 600 shares to sell at 32.01, 1000 shares to buy at 32.00, 1500 shares to buy at 31.99, and 15,000 shares to buy at 31.95.

The inside quote is:

| Stock | Inside bid | Inside Offer | Size |
|---|---|---|---|
| XYZ | 32.00 | 32.01 | 1,000 × 600 |

Floor traders have expressed firm interest on the buy and sell side and the specialist has set the liquidity quote price levels at 31.95 and 32.05 respectively. The liquidity quote is:

| Stock | Liquidity Bid | Liquidity Offer | Size |
|---|---|---|---|
| XYZ | 31.95 | 32.05 | 20,000 × 10,000 |

The specialist receives a DOT order to sell 5000 shares at the market. The specialist trades 1000 shares at the inside bid of 32.00, 1500 shares at the limit order price of 31.99, and trades the other 2500 shares at the liquidity bid of 31.95.

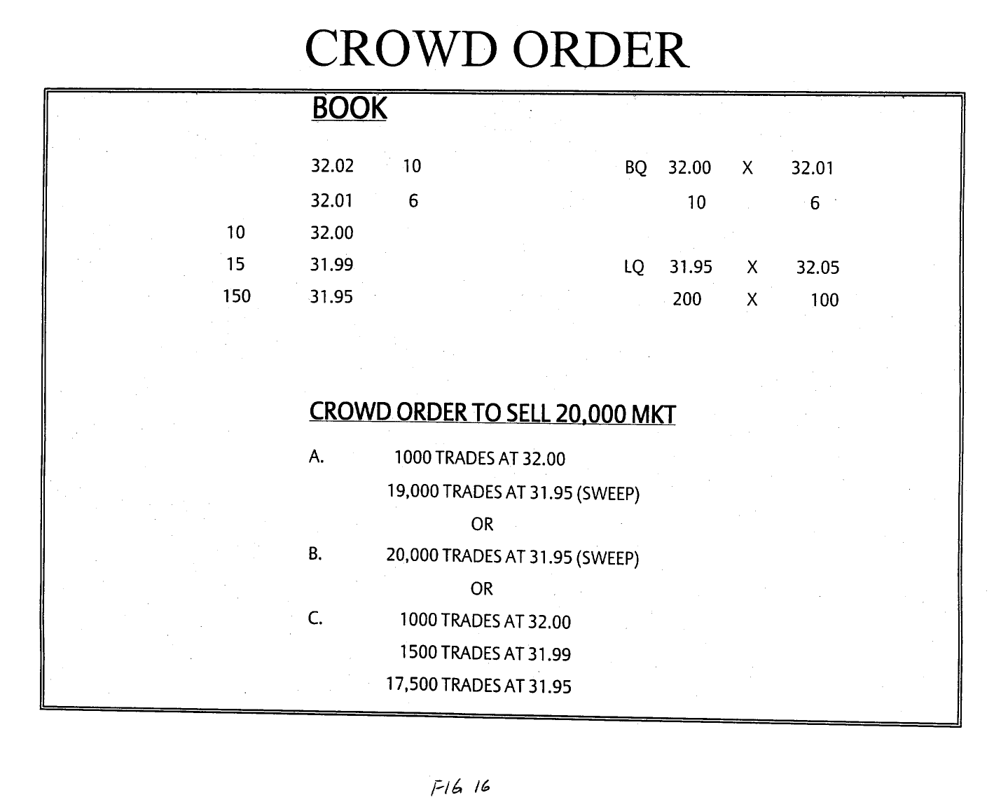

In another example, illustrated in FIG. 16, the limit orders on the specialist's limit order display book include 1000 shares to sell at 32.02, 600 shares to sell at 32.01, 1000 shares to buy at 32.00, 1500 shares to buy at 31.99, and 15,000 shares to buy at 31.95.

The inside quote is:

| Stock | Inside Bid | Inside Offer | Size |
|---|---|---|---|
| XYZ | 32.00 | 32.01 | 1,000 × 600 |

Floor traders have expressed firm interest on the buy and sell side and the specialist has set the liquidity quote price levels at 31.95 and 32.05 respectively. The liquidity quote is:

| Stock | Liquidity Bid | Liquidity Offer | Size |
|---|---|---|---|
| XYZ | 31.95 | 32.05 | 20,000 × 10,000 |

A trader in the crowd gives the specialist an order to sell 20,000 shares at the market. There are three possible alternatives for execution of the order.

In one alternative, the specialist trades 1000 shares at the inside bid of 32.00, and trades the other 19,000 shares at the liquidity bid of 31.95. The limit orders to buy 1500 shares at 31.99 get the advantage of price improvement and are traded at 31.95.

In another alternative, the specialist trades 20,000 shares at the liquidity bid of 31.95. The limit orders to buy 1000 shares at 32.00 and 1500 shares at 31.99 all get the advantage of price improvement and are traded at 31.95.

In another alternative, the specialist trades 1000 shares at the inside bid of 32.00, 1500 shares at the limit price of 31.99 and trades the other 17,500 shares at the liquidity bid of 31.95. None of the limit orders on the specialist's limit order display book get price improvement.

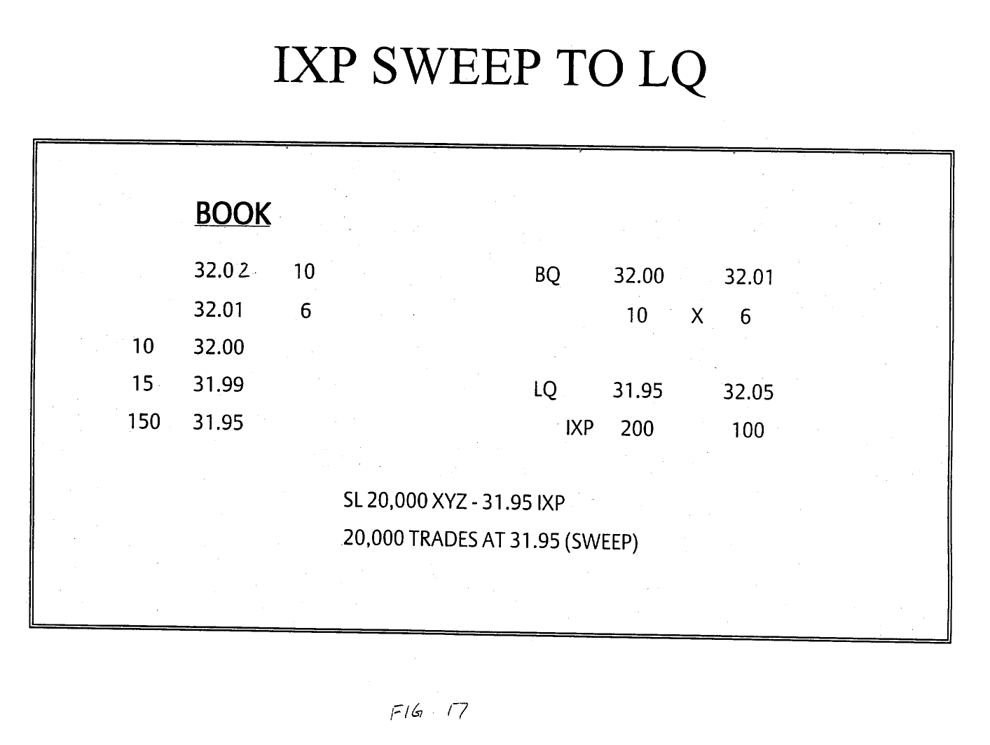

In another example, illustrated in FIG. 17, the limit orders on the specialist's limit order display book include 1000 shares to sell at 32.02, 600 shares to sell at 32.01, 1000 shares to buy at 32.00, 1500 shares to buy at 31.99, and 15,000 shares to buy at 31.95.

The inside quote is:

| Stock | Inside Bid | Inside Offer | Size |
|---|---|---|---|
| XYZ | 32.00 | 32.01 | 1,000 × 600 |

Floor traders have expressed firm interest on the buy and sell side and the specialist has set the liquidity quote price levels at 31.95 and 32.05 respectively. The liquidity quote is:

| Stock | Liquidity Bid | Liquidity Offer | Size |
|---|---|---|---|
| XYZ | 31.95 | 32.05 | 20,000 × 10,000 |

The liquidity quote has met certain requirements, and therefore the liquidity quote is eligible for Institutional Express (“IXP”) order execution. Institutional Express orders are generally described in Member Firm Notification Institutional Express, Dec. 4, 2001, the disclosure of which is incorporated herein by reference.

The specialist receives an electronic order designed for Express execution (IXP) to sell 20,000 shares at the liquidity bid price of 31.95. Through an automated process, the specialist trades 20,000 shares at the liquidity bid price of 31.95. The limit orders to buy 1000 shares at 32.00 and 1500 shares at 31.99 all get the advantage of price improvement and are traded at 31.95.

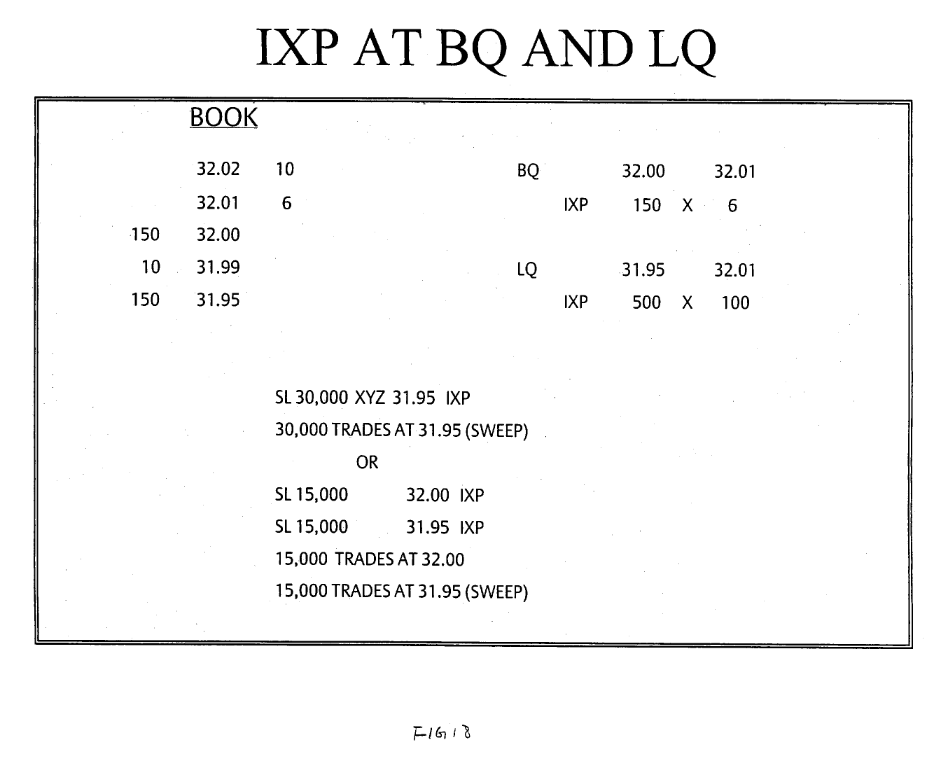

In another example, illustrated in FIG. 18, the limit orders on the specialist's limit order display book include 1000 shares to sell at 32.02, 600 shares to sell at 32.01, 15,000 shares to buy at 32.00, 1000 shares to buy at 31.99, and 15,000 shares to buy at 31.95.

The inside quote is:

| Stock | Inside Bid | Inside Offer | Size |
|---|---|---|---|
| XYZ | 32.00 | 32.01 | 15,000 × 600 |

Floor traders have expressed firm interest on the buy and sell side and the specialist has set the liquidity quote price levels at 31.95 and 32.01 respectively. The liquidity quote is:

| Stock | Liquidity Bid | Liquidity Offer | Size |
|---|---|---|---|
| XYZ | 31.95 | 32.01 | 50,000 × 10,000 |

Both the inside quote and the liquidity quote have met certain requirements, and therefore they are eligible for Institutional Express (“IXP”) order execution.

In one example, the specialist receives an electronic order designed for Express execution (IXP) to sell 30,000 shares at the liquidity bid price of 31.95. Through an automated process, specialist trades 30,000 shares at the liquidity bid price of 31.95. The limit orders to buy 15,000 shares at 32.00 and 1000 shares at 31.99 all get the advantage of price improvement and are traded at 31.95.

In another example, the specialist receives one electronic order designed for Express execution (IXP) to sell 15,000 shares at the inside bid price of 32.00 and another electronic order designated for Express execution (IXP) to sell 15,000 shares at the liquidity bid price of 31.95. Through an automated process, specialist trades 15,000 shares at the inside bid price of 32.00 and trades 15,000 shares at the liquidity bid price of 31.95. The limit orders to buy 1000 shares at 31.99 get the advantage of price improvement and are traded at 31.95.

Although illustrative embodiments have been described herein in detail, it should be noted and will be appreciated by those skilled in the art that numerous variations may be made within the scope of this invention without departing from the principle of this- invention and without sacrificing its chief advantages. As an example of those variations, the techniques for automatically setting the liquidity quote prices and/or the bunching parameters, which are described for a floor-less auction market, can be used with a securities exchange that has an auction floor.

The description and examples have used stocks as the security. However, it is also possible that the security is any form of equity security, an interest, a unit, a derivative, a right, a warrant, an option, shares of an exchange traded fund, or a futures contract.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims. that follow.

We claim:

1. A method to establish a liquidity quote of a security, the method comprising:
determining an inside quote of the security, the inside quote including a bid and an offer;
identifying the size and price of firm orders and firm interest in the security outside the bid and offer of the inside quote; and
establishing a liquidity quote of the security by using a predetermined set of criteria and the identified size and price of the firm orders and firm interest outside the bid and offer of the inside quote.

2. A method according to claim 1, further comprising publishing the liquidity quote.

3. A method according to claim 1, wherein the liquidity quote includes a bid or an offer price, the method further comprising:
executing a trade at the bid or offer price of the liquidity quote.

4. A method according to claim 1, wherein the security is a stock.

5. A method according to claim 1, wherein the security is one of an equity security, an interest, a unit, a derivative, a right, a share of an exchange traded fund, or a warrant.

6. A method according to claim 1, wherein the security is one of an option, a futures contract, or a derivative.

7. A method according to claim 1, wherein the firm interest includes firm interest from traders on a trading floor.

8. A method according to claim 1, wherein the firm interest includes firm interest from a specialist.

9. A method according to claim 1, wherein the firm interest includes anonymous firm interest.

10. A method according to claim 1, wherein the liquidity quote is a firm quote with size at a liquidity bid and size at a liquidity offer.

11. A method according to claim 1, wherein the liquidity quote includes only a bid.

12. A method according to claim 1, wherein the liquidity quote includes only an offer.

13. A method according to claim 1, wherein the liquidity quote includes both a bid and an offer.

14. A method for a specialist serving as the market maker for a particular security to establish a liquidity quote of the security, the method comprising:
determining an inside quote of the security, the inside quote including a bid and an offer;
identifying the size and price of firm orders and firm interest in the security outside the bid and offer of the inside quote, the firm interest from the trading floor and from the specialist;
establishing a liquidity quote as a firm liquidity quote of the security by using a bunching parameter and the identified size and price of the firm orders and firm interest outside the bid and offer of the inside quote, wherein the firm liquidity quote has size at a liquidity bid price and size at a liquidity offer price.

15. Computer executable software code transmitted as an information signal, the code to establish a liquidity quote of a security, the code comprising:
code to determine an inside quote of the security, the inside quote including a bid and an offer;
code to identify the size and price of firm orders and firm interest in the security outside the bid and offer of the inside quote; and
code to establish a liquidity quote of the security by using a predetermined set of criteria and the identified size and price of the firm orders and firm interest outside the bid and offer of the inside quote.

16. A computer-readable medium having computer executable software code stored thereon, the code to establish a liquidity quote of a security, the code comprising:
code to determine an inside quote of the security, the inside quote including a bid and an offer;
code to identify the size and price of firm orders and firm interest in the security outside the bid and offer of the inside quote; and
code to establish a liquidity quote of the security by using a predetermined set of criteria and the identified size and price of the firm orders and firm interest outside the bid and offer of the inside quote.

17. A programmed computer to establish a liquidity quote of a security, comprising:
a memory having at least one region for storing computer executable program code; and
a processor for executing the program code stored in the memory; wherein the program code comprises:
code to determine an inside quote of the security, the inside quote including a bid and an offer;
code to identify the size and price of firm orders and firm interest in the security outside the bid and offer of the inside quote; and
code to establish a liquidity quote of the security by using a predetermined set of criteria and the identified size and price of the firm orders and firm interest outside the bid and offer of the inside quote.

18. A method for updating a liquidity quote of a particular security, the method comprising:
determining an inside quote of the security, the inside quote including a bid and an offer;
identifying the size and price of orders for the security outside the bid and offer of the inside quote;
establishing a liquidity quote of the security by using the identified size and price of the orders outside the bid and offer of the inside quote;
updating the inside quote on a regular basis; and
updating the liquidity quote on a less frequent basis than the inside quote, wherein
the basis for updating the liquidity quote uses a predetermined parameter.

19. A method according to claim 18, wherein the regular basis for updating the inside quote is substantially after each trade of the security

20. A method according to claim 18, wherein the predetermined parameter includes a bunching parameter.

21. A method according to claim 18, wherein the predetermined parameter considers a number of events.

22. A method according to claim 21, wherein the number of events is a number of trades.

23. A method according to claim 21, wherein the number of events is a number of orders.

24. A method according to claim 21, wherein the number of events is a number of cancels.

25. A method according to claim 18, wherein the predetermined parameter considers a number of events since a last update of the liquidity quote.

26. A method according to claim 25, wherein the number of events is a number of trades of shares.

27. A method according to claim 25, wherein the number of events is a number of trades of interests, units, derivatives, rights, or warrants.

28. A method according to claim 18, wherein the predetermined parameter considers size and price of orders at or outside the bid or offer of the inside quote.

29. A method for updating quotes of a particular security, the method comprising:
determining an inside quote of the security, the inside quote including a bid and an offer;
updating and publishing the inside quote, the update occurring substantially after each trade of the security;
identifying the size and price of orders for the security outside the bid and offer of the inside quote;
establishing a liquidity quote of the security by using the identified size and price of the orders outside the bid and offer of the inside quote; and
updating and publishing the liquidity quote on a less frequent basis than the inside quote, wherein the basis for updating the liquidity quote uses a predetermined bunching parameter that considers the number of trades, orders and cancels of the security.

30. Computer executable software code transmitted as an information signal, the code for updating a liquidity quote of a particular security, the code comprising:
code to determine an inside quote of the security, the inside quote including a bid and an offer;
code to identify the size and price of orders for the security outside the bid and offer of the inside quote;
code to establish a liquidity quote of the security by using the identified size and price of the orders outside the bid and offer of the inside quote;
code to update the inside quote on a regular basis; and
code to update the liquidity quote on a less frequent basis than the inside quote, wherein the basis for updating the liquidity quote uses a predetermined parameter.

31. A computer-readable medium having computer executable software code stored thereon, the code for updating a liquidity quote of a particular security, the code comprising:
code to determine an inside quote of the security, the inside quote including a bid and an offer;
code to identify the size and price of orders for the security outside the bid and offer of the inside quote;
code to establish a liquidity quote of the security by using the identified size and price of the orders outside the bid and offer of the inside quote;
code to update the inside quote on a regular basis; and
code to update the liquidity quote on a less frequent basis than the inside quote, wherein the basis for updating the liquidity quote uses a predetermined parameter.

32. A programmed computer for updating a liquidity quote of a particular security, comprising:
a memory having at least one region for storing computer executable program code; and
a processor for executing the program code stored in the memory; wherein the program code comprises:
code to determine an inside quote of the security, the inside quote including a bid and an offer;
code to identify the size and price of orders for the security outside the bid and offer of the inside quote;
code to establish a liquidity quote of the security by using the identified size and price of the orders outside the bid and offer of the inside quote;
code to update the inside quote on a regular basis; and
code to update the liquidity quote on a less frequent basis than the inside quote, wherein the basis for updating the liquidity quote uses a predetermined parameter.

33. A method for effecting a transaction for a particular security, the method comprising:
receiving a liquidity quote of the security, the liquidity quote reflecting identified size and price of firm orders and firm interest in the security outside a bid and an offer of an inside quote of the security; and
effecting a transaction for the security, the transaction having a transaction price and a transaction size, wherein the transaction price is equal to an offer price of the liquidity quote or equal to a bid price of the liquidity quote, and the transaction size is equal to or less than the respective size of the offer price or bid price of the liquidity quote.

34. A method according to claim 33, wherein the transaction is a transaction for the sale or purchase of stock.

35. A method according to claim 33, wherein the transaction is a transaction for the sale or purchase of one of an equity security, an interest, a unit, a derivative, a right, a share of an exchange traded fund, or a warrant.

36. A method according to claim 33, wherein the transaction is a transaction for the sale or purchase of one of an option, a futures contract, or a derivative.

37. Computer executable software code transmitted as an information signal, the code for effecting a transaction for a particular security, the code comprising:
code to receive a liquidity quote of the security, the liquidity quote reflecting identified size and price of firm orders and firm interest in the security outside a bid and an offer of an inside quote of the security; and
code to effect a transaction for the security, the transaction having a transaction price and a transaction size, wherein the transaction price is equal to an offer price of the liquidity quote or equal to a bid price of the liquidity quote, and the transaction size is equal to or less than the respective size of the offer price or bid price of the liquidity quote.

38. A computer-readable medium having computer executable software code stored thereon, the code for effecting a transaction for a particular security, the code comprising:
code to receive a liquidity quote of the security, the liquidity quote reflecting identified size and price of firm orders and firm interest in the security outside a bid and an offer of an inside quote of the security; and
code to effect a transaction for the security, the transaction having a transaction price and a transaction size, wherein the transaction price is equal to an offer price of the liquidity quote or equal to a bid price of the liquidity quote, and the transaction size is equal to or less than the respective size of the offer price or bid price of the liquidity quote.

39. A programmed computer for effecting a transaction for a particular security, comprising:
a memory having at least one region for storing computer executable program code; and
a processor for executing the program code stored in the memory; wherein the program code comprises:
code to receive a liquidity quote of the security, the liquidity quote reflecting identified size and price of firm orders and firm interest in the security outside a bid and an offer of an inside quote of the security; and
code to effect a transaction for the security, the transaction having a transaction price and a transaction size, wherein the transaction price is equal to an offer price of the liquidity quote or equal to a bid price of the liquidity quote, and the transaction size is equal to or less than the respective size of the offer price or bid price of the liquidity quote.
